(19) United States
(12) Patent Application Publication
(10) Pub. No.: US 2014/0027445 A1
(43) Pub. Date: Jan. 30, 2014

(54) MIXING APPARATUS

(71) Applicant: Marion Mixers, Inc., Marion, IA (US)

(72) Inventors: Timothy C. Scheurs, Amana, IA (US); Stephen M. Rogers, Marion, IA (US); Tom L. Allison, Ely, IA (US); Jeffrey Leon Evans, Robins, IA (US); Jared Michael Lenth, Farmersburg, IA (US); Gregory Jon Stover, Cedar Rapids, IA (US); Douglas Edward Grunder, Mt. Vernon, IA (US); John Osepchuk, Concord, MA (US)

(73) Assignee: Marion Mixers, Inc., Marion, IA (US)

(21) Appl. No.: 13/950,402

(22) Filed: Jul. 25, 2013

Related U.S. Application Data
(60) Provisional application No. 61/676,396, filed on Jul. 27, 2012.

(51) Int. Cl. H05B 6/80

(52) U.S. Cl. CPC H05B 6/80
USPC 219/679

(57) ABSTRACT

An apparatus is provided for heating and processing a product. A mixing bowl includes a rounded base portion, an extended upper portion and two end walls. An agitator is positioned within the base of the bowl for rotation about a rotational axis and in a closely spaced relation with the bowl. The agitator includes a drive shaft having a portion thereof projecting outwardly of the mixing bowl. The agitator having a rotational path closely spaced with the inside wall of the base portion and spaced from the upper portion of the bowl. An outwardly flared transition maybe provided between the base and upper portion of the bowl. A microwave energy source is directed into the bowl for heating the product. A choke surrounds the agitator shaft to form a seal for the bowl to prevent microwave leakage.

### RELATED APPLICATION

The present application claims the benefit of the filing of U.S. Provisional Application No. 61/676,396, filed Jul. 27, 2012.

### FIELD OF THE INVENTION

The present disclosure relates to a mixing apparatus for heating and processing of a product. The heating process within the apparatus is performed by application of microwave energy.

### BACKGROUND

It is known to use microwave energy to heat a product on a continuous or batch basis, where the product is a particulate material, a liquid or slurry. The heating may be performed for the purpose of cooking the product, reducing the moisture content of the product or to otherwise process the product. In some applications means is provided for mixing the product during heating.

US 2010/0132210 to Kruger shows a drying device with mixing blades positioned in a horizontal bowl. A heating device is used in the process, with microwave energy being one option for supplying heat to the product.

U.S. Pat. No. 4,882,851 to Wennerstrum et al shows a device for batch drying of a powdered or particulate product by means of a microwave vacuum system. The device includes a vacuum means to withdraw liquid from the process chamber. An agitator is provided in the drying chamber.

U.S. Pat. No. 5,174,864 to Arbizzani et al shows a heating unit for extracting liquid from sludge using microwave energy. A mixer is positioned at the bottom of the drying chamber.

U.S. Pat. No. 5,400,524 to Crosnier Leconte et al shows a device for drying a granular or powdered product having a dielectric duct with a microwave applicator therein. A rotating metal screw is positioned in the duct to convey the product. The screw includes at least one helically wound wire that extends along the duct and is spaced from the duct wall.

U.S. Pat. No. 7,219,442 to Laible shows a drying method for a powdered product having a horizontally positioned, heated chamber and a stirrer closely spaced with the chamber wall and positioned adjacent an injection line for the product.

U.S. Pat. No. 5,939,071 to Joseph shows a process for producing a pharmaceutical having a controlled heating of the product and includes a chopper and a stirrer within the process chamber.

U.S. Pat. No. 5,857,264 to Debolini shows a dryer for a powdered product having a mixer within a drying chamber. The mixer includes a series of paddle blades mounted on a shaft that is eccentrically positioned within the drying chamber.

U.S. Pat. No. 2,552,360 to Zichis shows a dehydrating apparatus having a heated chamber with a rotating mixer therein. The mixer includes a plurality of scraper blades extending from the central shaft and a pair of rollers having toothed surface for crushing the product within the chamber.

### SUMMARY OF THE INVENTION

The present disclosure relates to an apparatus for heating and processing a product. A mixing bowl is provided for retaining a quantity of product. The bowl includes a rounded or downwardly semi-circular base portion, an extended upper portion and two end walls. An agitator is positioned within the bowl for rotation about a preferably horizontal rotational axis. The agitator is positioned within the base portion and includes a rotational path with an outer periphery that is closely spaced with the inside wall of the base portion. The extended upper portion of the bowl is spaced from the periphery of the agitator rotational path a sufficient distance to prevent arcing between the wall of the upper portion of the bowl and the agitator. A motor is provided for rotation of the agitator about the rotational axis. The agitator includes a drive shaft positioned along the rotational axis, with a portion of the shaft projecting outwardly of at least one end wall of the mixing bowl. A microwave energy source is directed into the bowl for heating the product. A choke surrounds the outwardly projecting shaft portion. The choke forming a microwave leakage seal between the bowl and the shaft.

In a further aspect of the disclosure, the bowl of the apparatus may include an outwardly flared transition wall is formed between the base and upper portion of the bowl. The outwardly flared portion may initiate within the bowl wall adjacent the position of the axis of the shaft. The upper end of the outwardly flared transition may be formed level with or at a position above a fill-line for product within the bowl.

In a further aspect of the disclosure, the agitator is formed a series of paddle having scraper blades or other structures mounted on arms that project outwardly from the shaft. The blades define the rotational path of the agitator. The blades may be angled with respect to the axial dimension of the bowl for promoting mixing of the product within the bowl.

In a further aspect of the disclosure, the choke surrounding the agitator shaft may include a first collar closely spaced with and surrounding the shaft and an outer sealing collar surrounding the first collar and radially spaced therefrom. The fist collar and the sealing collar are preferably fixed to an end wall of the bowl. The radial spacing between the first collar and the sealing collar communicates with the spacing between the first collar and the shaft. Preferably, the shaft spacing of the first color is less than the radial spacing with the outer sealing collar. A sealing cap may be formed axially outwardly of the sealing collar.

In a further aspect of the disclosure, a hinged lid is provided for covering an opening in the bowl formed adjacent the extended upper end of the bowl. The lid sealing the bowl in a closed position. A series of ports may be provided for providing access to the interior of the bowl. A least one port connected to the microwave energy source and directing the microwave energy into the bowl.

Other features of the present invention and combinations of features will become apparent from the detailed description to follow, taken in conjunction with the accompanying drawings.

### BRIEF DESCRIPTION OF THE DRAWINGS

For the purpose of illustrating the invention, the drawings show forms that are presently preferred. It should be understood that the invention is not limited to the precise arrangements and instrumentalities shown in the drawings.

FIG. 1 shows perspective view of an embodiment of a mixing apparatus having features contemplated by the present disclosure.

FIG. 2 shows an elevation view of one end of the mixing apparatus of FIG. 1, with the side wall of the mixer bowl and the agitator shown in phantom.

FIG. 2A shows an enlarged view of a portion of the mixing apparatus of FIG. 2, with certain structures removed for illustration purposes.

FIG. 3 shows an elevation view of one end of the mixing apparatus, opposite from that shown in FIG. 2, with the side wall of the mixer bowl and the agitator shown in phantom.

FIG. 4 shows an elevation view of one side of the mixing apparatus of FIG. 1 with the end wall of the mixer bowl and the agitator shown in phantom.

FIG. 4A shows an enlarged view of a portion of the mixing apparatus of FIG. 4, with certain structures removed for illustration purposes.

FIG. 4B shows the mixing apparatus of FIG. 4 with the side wall of the mixer bowl removed for illustration of the agitator within the mixing chamber.

FIG. 5 shows a top plan view of the mixing apparatus of FIG. 1 with the opening into the bowl shown in phantom.

FIG. 6 shows a perspective view of choke member surrounding an agitator drive shaft with the mixing apparatus.

FIG. 7 shows an elevation view of the choke member and the agitator drive shaft as contemplated by FIG. 6.

FIG. 8 shows a cross section view of the choke member as taken along line 8-8 in FIG. 7.

FIGS. 9-11 show various views of a clean-in-place nozzle for mounting on the mixing apparatus.

### DETAILED DESCRIPTION

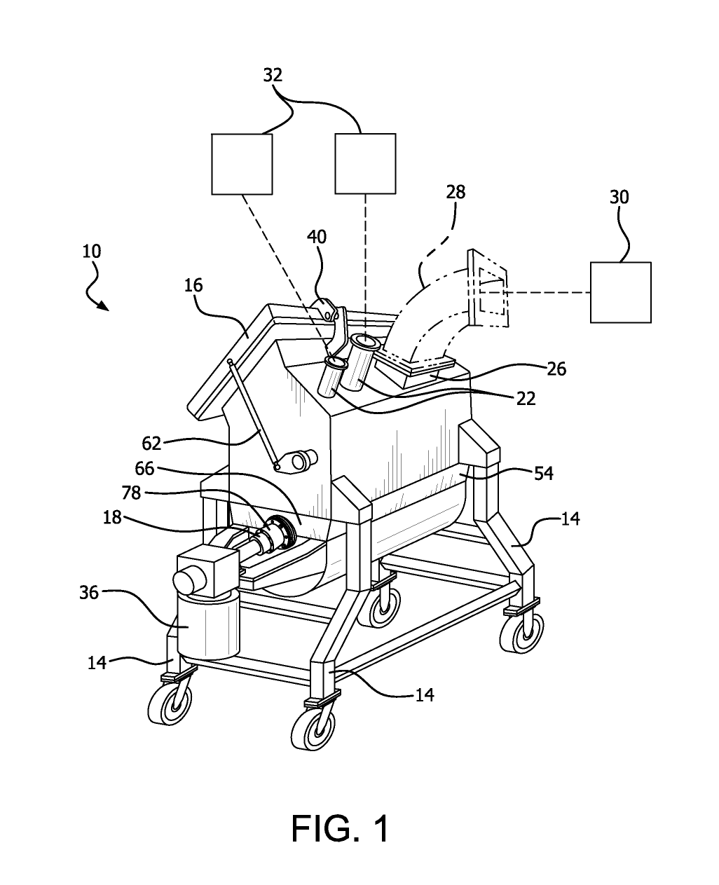

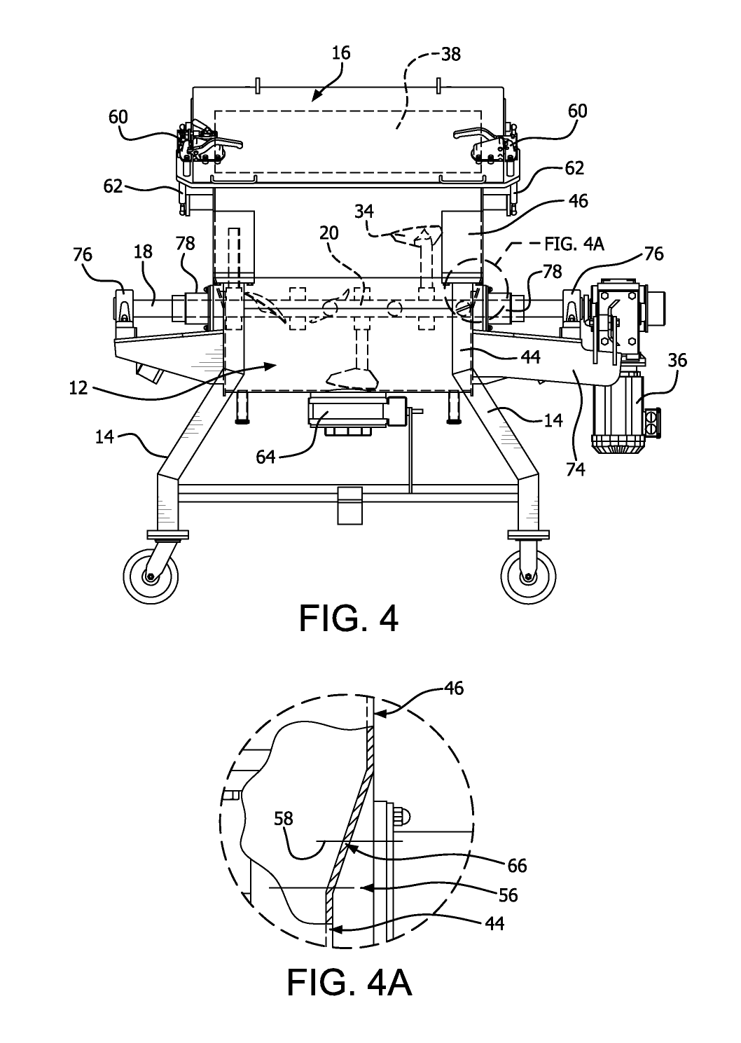

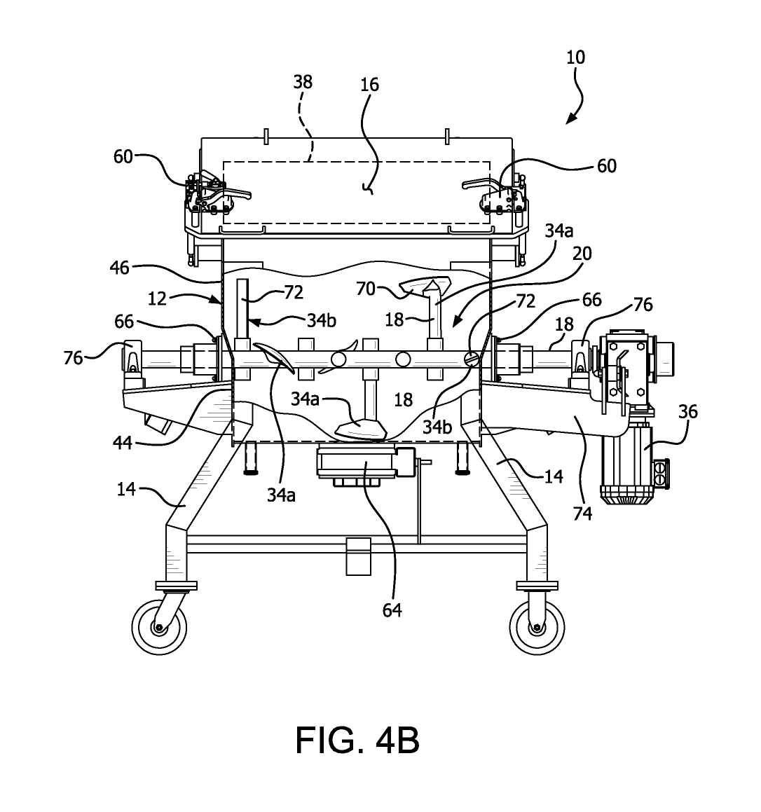

In the figures, where like numerals identify like elements, there is shown an embodiment of a mixer or mixing apparatus generally designated by the numeral 10. The mixer 10 includes a bowl 12 supported by legs 14. As shown, wheels are provided on the legs, making the mixer 10 portable. The mixer 10 defines a closed mixing chamber formed by the bowl 12 and a hinged cover or lid 16. The lid 16 closes an access opening (see FIG. 4) into the bowl 12. A series of ports 22 are provided for access into (and out of) the chamber defined by the bowl. A further port 26 is provided for the introduction of microwave energy into the chamber. As shown in FIG. 1, a duct 28 is fixed to microwave port 26. Duct 26 is contemplated to be connected to (via other ductwork, or otherwise) a wave guide or generator for supplying the microwave energy into the chamber. The microwave generator is generally designated by a black box structure 30. In addition, the fluid source is generally identified by black box structures 32. (A further duct opening or port 24 is shown in FIG. 5 and discussed below.) An agitator 20 (see, e.g., FIG. 4B) is provided within the mixing chamber. The agitator 20 includes a series of paddles 34 mounted on a rotational shaft 18. The shaft 18 extends the length of the bowl 12 and is driven by a motor 36 attached at one end of the mixer 10.

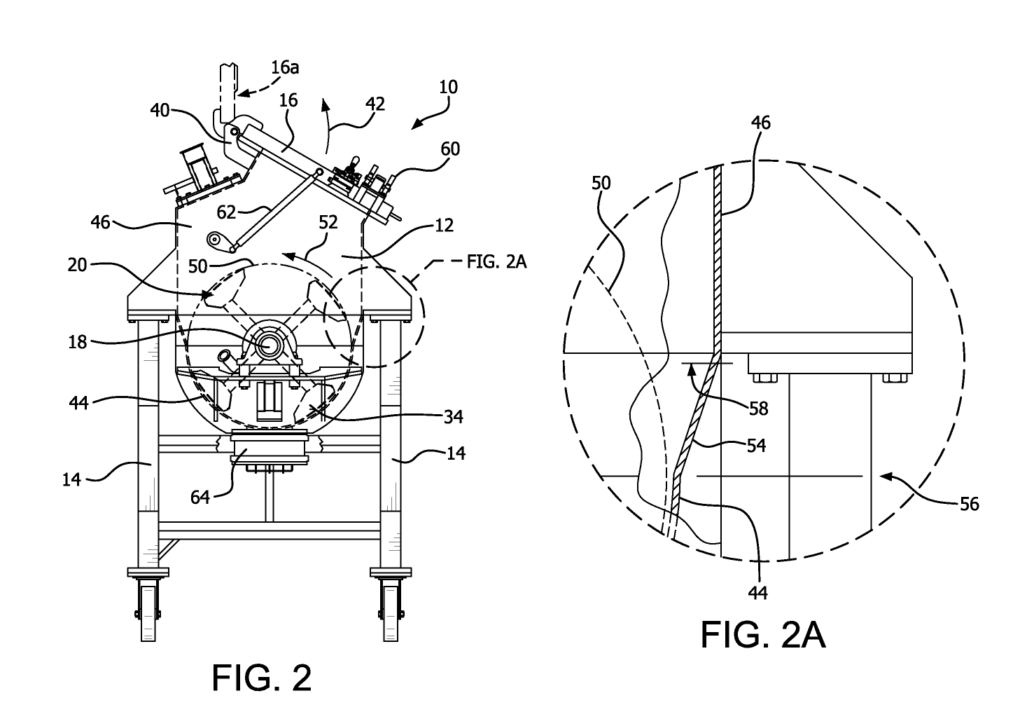

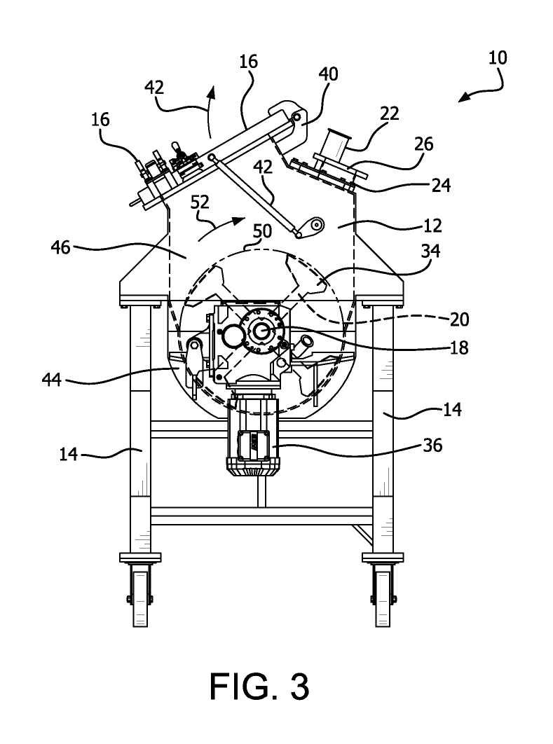

The mixer 10 as shown is for batch processing of product, as compared to the continuous processing of product. The lid 16 is provided to cover an inlet opening 38, see FIG. 4. The lid 16 pivots with respect to the bowl 12 by means of a hinge 40. The lid 16 rotates (see arrow 42 in FIGS. 2 and 3) to expose the opening 38 and to provide access into the mixing chamber within the bowl 12. The bowl 12 is asymmetrical in that there is a rounded or downwardly semi-circular bottom or base portion 44 and extended, generally rectangular top portion 46. The agitator 20 is positioned within the base portion 44 of the bowl 12. The agitator 20 includes a series of paddles 34 that are rotated by the shaft 18 and define a rotational path. The extension of the paddles 34 defines the outer periphery of the rotational path and is identified by the circular dotted line 50. The outer periphery of the rotational path is positioned closely adjacent the curved inside wall of the base 44 of the bowl 12. The direction of rotation is indicated by arrow 52. It is noted that the direction of rotation and the rotational speed may vary for purposes of mixing and discharge from the bowl. For example, it may be advantageous for the rotation to be reversed during one or more portions of the product processing. Alternatively or in addition thereto, the agitator rotation may be stopped during a portion of the process. The product being processed within the mixer, the form of the agitator and the timing of the microwave energy are three of the potential parameters that may affect the speed and direction of the agitator.

In FIG. 2A, there is shown a portion of the wall of the bowl 12 at the transition between the bottom portion 44 and the top portion 46. A transition wall 54 is provided and starts about the position of the centerline 56 of the circular path 50 of the agitator paddles 34. The transition wall 54 flares outwardly from the base portion 44 of the bowl 12 and joins with the rectangular upper portion 46 of the bowl 12. The positioning of the transition wall 54 and the amount of flare provided are intended to space the paddles 34 from the inside wall of the bowl 12 as the paddles 34 move out of the product within the chamber. In the preferred operation of the mixer 12, the product batch within the bowl 12 will fill the chamber to a line level with or greater than the position of the shaft 18, which lies along the centerline or axis 56 of the rotation 50 of the agitator 20. As shown in FIG. 2A, this fill line 58 is positioned above the middle of rotational path 56 and preferably at least level with the upper edge of the transition wall 54, at the connection with the upper portion 46 of the bowl 12. Based on the dimensional positioning created by the flare of the transition wall 54, the paddles 34 are spaced from the inside wall of the upper portion 46 of the bowl 12. Hence, arcing of the microwave energy between the bowl wall and the paddles 34 is prevented and substantially eliminated. When the paddles 34 move within the curved base portion 44 of the bowl 12, the end of the paddles 34 are positioned closely adjacent the inside surface of the bowl 12, for a maximum lifting and mixing of the product.

In FIG. 2, the lid 16 is shown in the down or closed position, covering the inlet opening 38 (FIG. 5). Latches 60 are provided adjacent the opening 38 to engage the lid 16 with the bowl 12. When the latches 60 are released, the lid 16 may be pivoted about the hinge 40 to an open position (labeled 16a and partially shown in phantom in FIG. 2). A piston 62 connects the lid 16 to the bowl 12 and assists in moving the lid between the open and closed positions. A second piston 62 is provided on the opposite side of the lid 16 and bowl 12, as shown in FIG. 3. When the lid 16 is open, product may be introduced into the bowl 12 for processing. A valve 64 is positioned at the bottom of the bowl and may be opened for discharge of the processed product into a hopper or a connected transfer pipe (not shown). The valve communicates with a discharge opening within the bottom of the bowl 12. The agitator 20 may be rotated to assist in moving product through the valve 64. The valve may take the form of a Roto-Disc® spherical valve, manufactured by the Roto-Disc Company of Milford, Ohio.

In FIG. 4A, there is shown a portion of the end wall of the bowl 12 at the transition between the bottom portion 44 and the top portion 46. The end transition wall 66 is similar to the transition wall 54 provided on the side walls of the bowl 12. The end transition wall 66 starts at the centerline 56 of the circular path 50 of the agitator paddles 34. The end transition wall 66 flares outwardly from the base portion 44 of the bowl 12 and joins with the rectangular upper portion 46 of the bowl. The position of the end transition wall 66 and the amount of flare provided are intended to space the paddles 34 on each end of the agitator 20 away from the inside of the end wall of the bowl 12 as the paddles 34 rotate out of the product. The fill line 58 is positioned above the centerline of rotation 56 and preferably adjacent the upper edge of the end transition wall 66, at the connection with the upper portion 46 of the bowl 12. The desired spacing substantially eliminates arcing with the end walls during application of microwave energy when the paddle is rotating outside of the product within the bowl 12.

The amount of separation between the agitator and the inside bowl wall at this product transition level is somewhat dependant on the materials being processed within the mixer. For example, a granular or powdered material may be less likely to create an arc during application of microwave energy as compared to a product having a high fat or grease content. The amount of spacing is contemplated to be a minimum of about 0.375 inch. In a preferred embodiment, the flare is preferable greater than or equal to about 3 inches. (A similar spacing is contemplated by transition wall 54.) However, the spacing at the bottom of the trough may be minimal without significant risk of arcing occurring, because of the product covering the agitator paddles in this area of the bowl. As an example, the spacing between the paddles and the inside of the bowl wall may at the bottom area of the bowl may be around 0.020 inches. A relatively close relationship is desirable for purposes of bowl clean out, through the valve.

In FIG. 4B, a portion of the sidewall of the bowl is broken away to expose the agitator 20, formed by the drive shaft 18 and a plurality of paddles 34. The central paddles 34a as shown are formed by angled shafts 68 having scraper blades 70 on the end. As shown, the outer paddles 34b positioned adjacent the end walls of the bowl 12 include a shaft formed as an angled blade 72, projecting outwardly from the agitator shaft 18 along the end wall and terminating adjacent the inside surface of the bottom portion 44 of the bowl 12. In the rotational position shown in FIG. 4B, the left side paddle 34b is spaced from end wall of the upper portion 46 of the bowl 12, due to the spacing created by the end transition wall 66. The right side paddle 34b is projecting outwardly from the agitator shaft (towards the viewer) and is closely spaced with the end wall of the base portion 44 of the bowl 12. Other agitator forms may be used within the mixer 10.

The drive motor 36 is mounted on support arm 74. The motor 36 is connected to the agitator shaft 18, which projects outside of the end walls of the bowl. Bearings 76 are provided on each end of the agitator shaft 18. A choke 78 is provided on each end wall of the bowl to prevent leakage of the microwave energy. The choke 78 may further serve to seal the bowl 12 to prevent product leakage around the shaft 18.

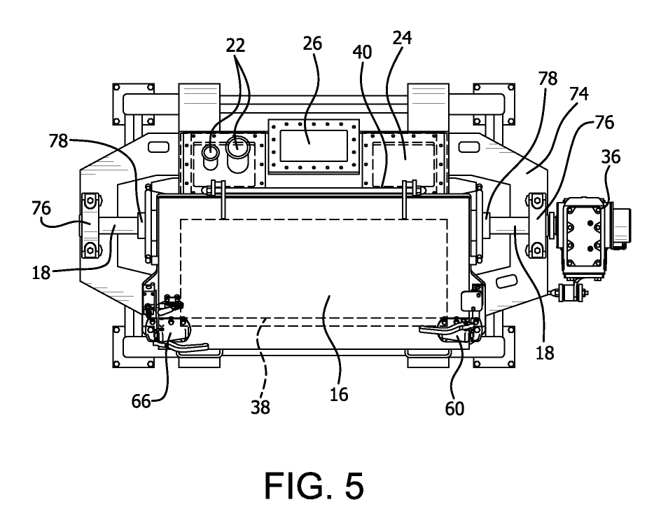

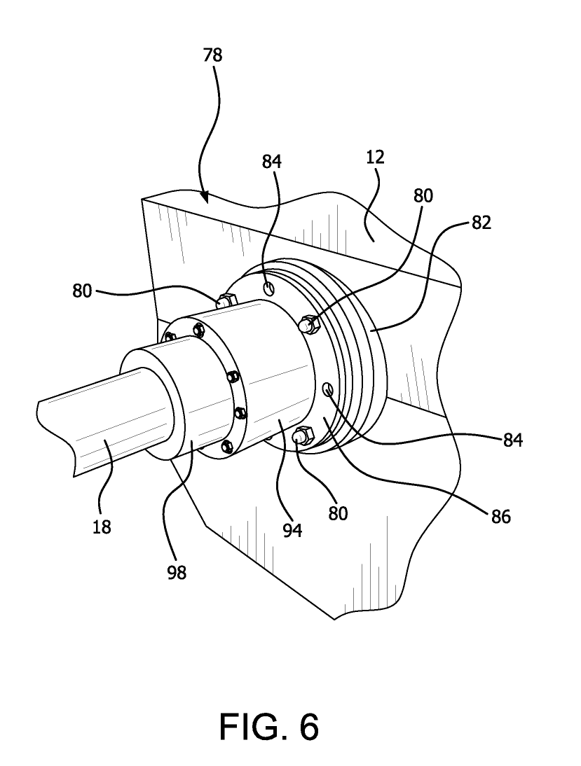

A close-up view of the choke 78 is shown in FIG. 6. The choke 78 is mounted on the end wall of the bowl 12 and surrounds the agitator shaft 18 as it projects from the bowl 12. FIG. 7 is an end view of the choke 78 and shows the mounting hardware and spacing. A series of threaded shafts 80 each project from a mount plate 82 secured to the wall of the bowl 12. The threaded shafts 80 alternate with pins 84 attached to a flange 86 formed on outer sealing portion 94 within the choke 78. The pins 84 project into openings within the mount plate 82. The threaded shafts 80 project outwardly of the sealing flange 86 and nuts are attached to secure the structure to the bowl 12. As shown, the spacing between the openings for the shafts 80 and the pins 84 is about 2.375 inches, which serves to prevent microwaves from moving outside choke. In addition, a series of nuts 130 are fixed to threaded shafts projecting from an outer portion 94 of the choke 78. The nuts 130 secure a sealing cap 98 to the end of the choke 78. The sealing cap 98 surrounds the agitator shaft 18 as it projects from the choke 78. Openings 132 are provided in a flange portion of the sealing cap. The openings 132 are formed are spaced at the same amount of 2.375 inches as are the shafts 80 and pins 84. Further, the openings 132 are elongated to permit adjustment of the position of the sealing cap 98 to accommodate minor variations in the rotation of the agitator shaft 18.

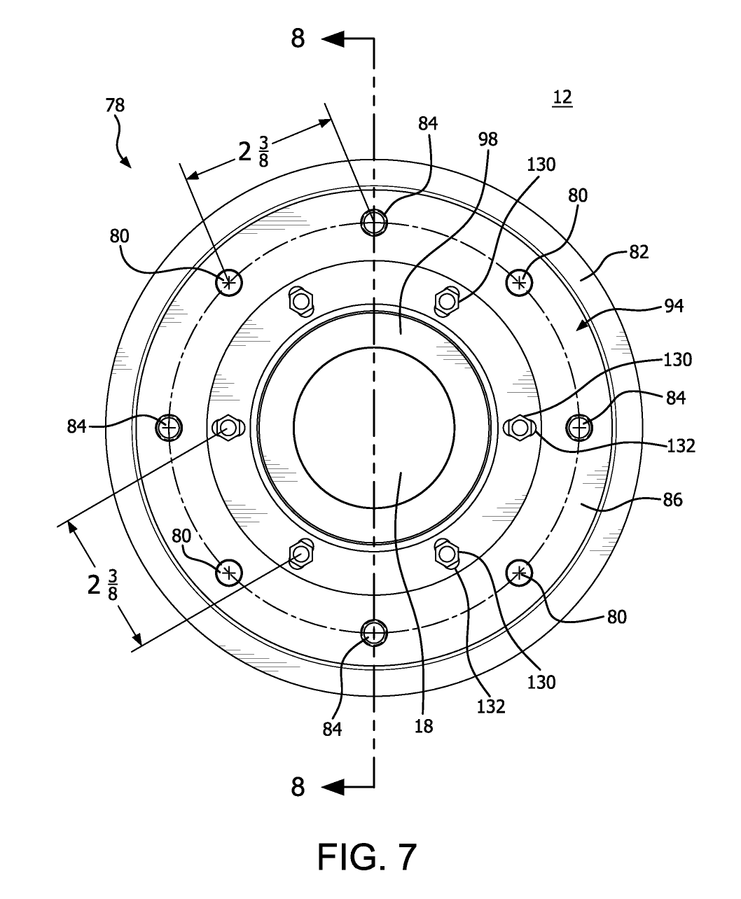

A cross sectional view of the choke 78 is shown in FIG. 8. The mounting plate 82 is welded to the wall of the bowl 12 and defines the opening for the agitator shaft 18. A first choke member 88 is secured within a trough within the mount plate 82. The first member 88 includes a flange 90 and a collar 92. The flange 90 is sandwiched between the mounting plate 82 and the sealing flange 86 of the outer sealing portion 94 and is secured to the bowl wall by the nuts provided on the ends of the threaded shafts 80. The outer sealing portion 94 includes the mounting flange 86 and an outer collar 96. The outer collar 96 surrounds and is spaced from the collar 92 of the first sealing portion 88. A sealing cap 98 is secured to the collar 96 of the outer sealing member 94. The sealing cap 98 surrounds a step 100 in the diameter of the agitator shaft 18.

Internally, a series of lip seals 102 are secured by the collar 90 of the first sealing member 88 and the mount plate 82. Each lip seal 102 includes a body portion 104. O-rings 106 are provided on a sealing ring 103 provided within the mount plate 82. The sealing ring 103 and collar 92 secure the lip seals 102 to the mount plate 82. In addition, a series of wipers blades 108 project from the body 104 of each lip seal 102 and contact the agitator shaft 18. The o-rings 106, sealing ring 103 and wipers 108 form an annular seal around the agitator shaft 18, deterring or preventing the movement of product from the bowl into the choke 78. Beyond the lip seals 102, the collar 92 of the first sealing member 90 extends parallel to the shaft 18. A clearance space 110 is defined between the outside surface of the agitator shaft 18 and the inside surface of the collar 92. At the projected end of the collar 92 a separation space 112 is defined with the inside surfaces of the outer collar 96. An end plate 118 is provided on the end of the collar 96 and forms the mounting surface for the end cap 98. The separation space 112 is formed between the end of first collar 92 and the end plate 118 and continues along the outer surface of the first collar 92 and the inner surface of the outer collar 96. The separation space 112 is greater than the agitator space 110. Further clearance 114 is provided between the end plate 118 and the outside surface of the agitator shaft 18. This further spacing 114 communicates with, but is narrower than, the separation space 112 and the clearance 110 between the first collar 92 and the shaft 18. Further clearance 116 is provided between the sealing cap 98 and the shaft 18 at the step 100 in the shaft 18.

The purpose of the dimensional differences in the defined spaces 110, 112 and 114 is to prevent travel of microwave energy along the shaft 18 and outside of the choke 78. The varying restriction directs the microwaves into the relatively open separation space 112 between the collars 92 and 96. The defined spacing for the mounting hardware 80, 84 serves to further cut off the migration of the microwave energy outside of the bowl.

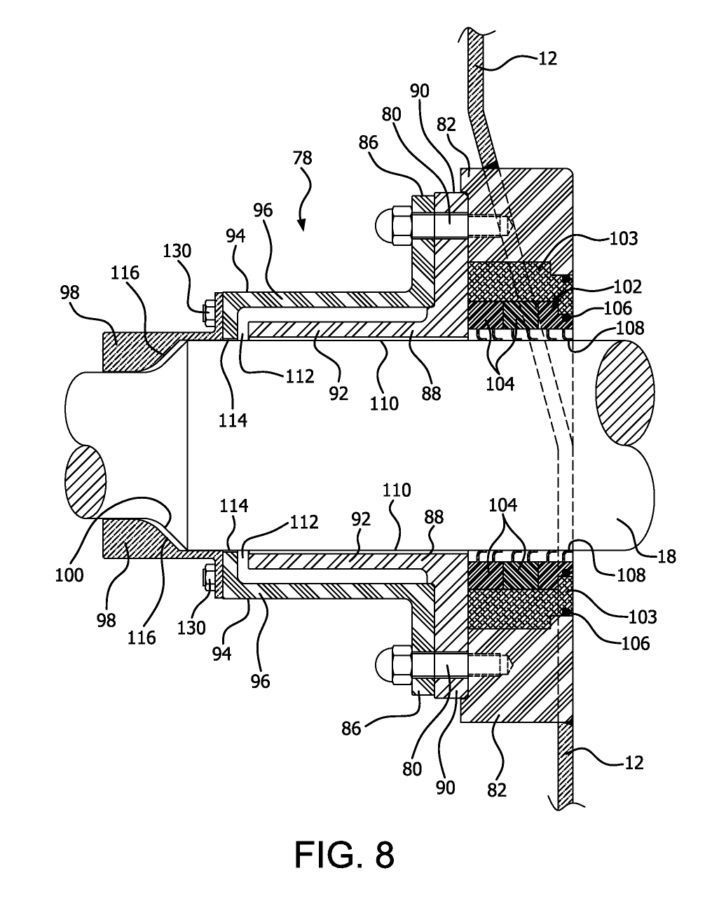

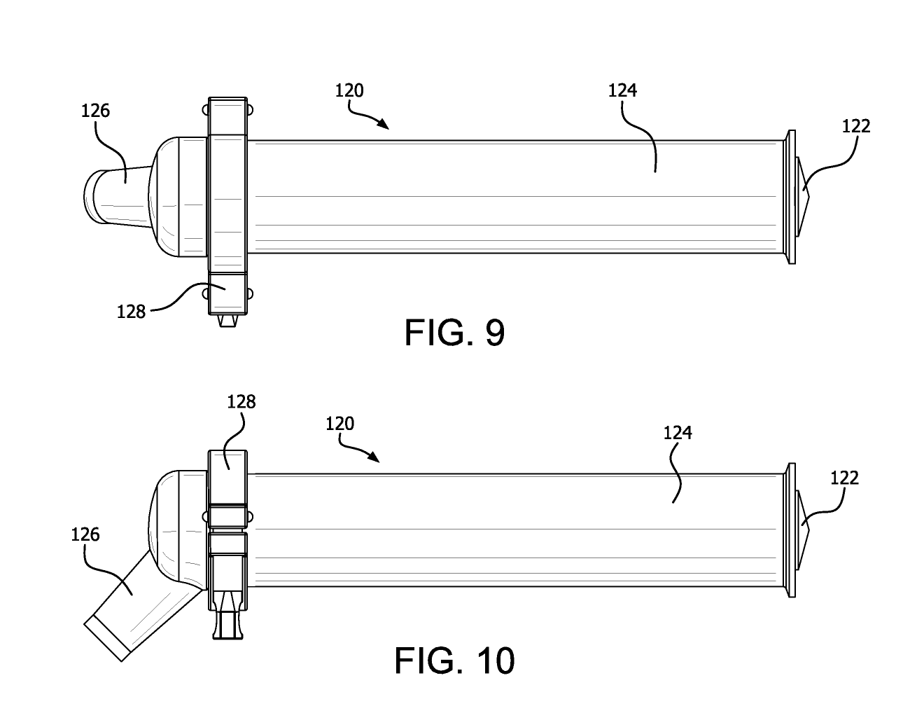

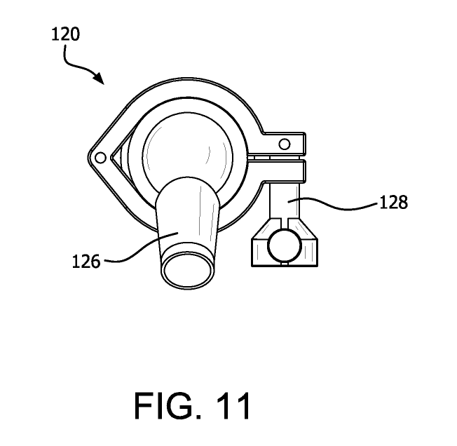

FIGS. 9-11 provide various views of a clean-in-place (CIP) nozzle 120. The nozzle 120 is contemplated to be inserted into one or more of the ports 22 provided on the top of the bowl 12 (see, e.g., FIG. 1). The nozzle 120 is preferably a liquid activated structure, where the spray head portion 122 is retractable into the nozzle body 124. Cleaning liquid or other fluids are input from a source 32 (FIG. 1) into the nozzle at the inlet 126 positioned at one end of the nozzle body 124. A collar 128 is provided adjacent the input end to fix the nozzle within the ports 22. The pressure from the liquid feed causes the spray head 122 to project from the body 124 and into the bowl 12 of the mixer 10. Because the spray head 122 is retractable, the nozzle 120 can remain within the port tube 22 during normal processing within the mixer 10. The diameter and positioning the rounded ports 22 are chosen to serve as a choke for microwave migration through the port. The nozzle may take a number of forms, including extendable CIP nozzles sold by Evaporator Dryer Technologies, Inc. of Hammond, Wis. Other devises may be used along with the ports 22, such as digital cameras, arc protection devices, temperature and moisture probes, gas measurement devices, nozzles for directing gas or fluid into the bowl, etc.

Microwave energy is input from a microwave generator 30 (FIG. 1) through the ductwork 28 and into the port 26. The microwave energy is applied to the product retained within the mixing chamber defined by the bowl 12. The microwave energy serves to heat the product within the mixing chamber, while the agitator 20 is rotated by the motor 36. The agitator paddles 34 serve to mix the product within the bowl, for even heating and release of solvents (or the like). In the drawings, the generator 30 is shown generically. One possible microwave generator may be an AMT7510 Transmitter assembly as sold by AMTek Microwaves of Cedar Rapids, Iowa. Larger wattage transmitters may be utilized and the transmitter output may be controllable for selective energy application into the mixer (or split into multiple mixers). Other programmable controls may also be included.

Generally, when the paddles 34 are moving within the product, the blades 70, 72 are closely spaced with the inside surface of the curved base portion 44 of the bowl 12. Preferably, the agitator centerline 56 is slightly offset from the center of the curved bowl portion. This offset preferably places the blades 70, 72 at their closest to the bowl wall at the bottom of the rotation. The relative position of the blades 70, 72 at the horizontal position would be slight more spaced from the bowl wall. As the blades 70, 72 move out of the product during rotation of the agitator 20, the formation of the extended upper portion of the bowl and/or the formation of the flared walls 54, 66 create a dimensional spacing between the blades 70, 72 and bowl wall to sufficient to prevent or otherwise inhibit microwave arcing between the blades and the inside bowl wall. Arcing may cause—among other things—localized or excessive heating of the product, creating a loss of product or a buildup of product on various surfaces within the mixing chamber.

As discussed, the product batch preferably fills the bowl to a level 58 above the centerline 56 of the agitator shaft 18 (see FIG. 2A). This preferred product level is contemplated to be about 60% of the internal volume of the chamber. The mixing chamber is defined by the portion of the bowl where the agitator rotates. Hence, the top of the mixing chamber portion is defined by top of the rotational arc of the agitator. It is further contemplated that the level of product in the mixing chamber may vary, depending on the material being processed. Again, a granular or powdered product material may be less likely to create an arc during application of microwave energy, as compared to a product having a high fat or grease content, and may have a occupy a lower level in the bowl without creation of an arcing problem. A lower level in the embodiment shown may be in the range of about 20 to 40% of the mixing chamber, which is a level below the agitator shaft 18.

The chokes 78 on the agitator shaft 18 are intended to both seal the bowl 12, preventing leakage of product, and prevent microwave exposure outside of the bowl. The ports 22, 26 also preferably restrict passage of microwaves outside of the bowl 12. The additional port 24 in the bowl 12 may be attached to a gas blower, vacuum source or the like to provide for a gas flow through the bowl for assisting in processing or to otherwise drive solvents from the product during heating. For example, nitrogen gas may be introduced into the bowl 12 to further prevent arcing. Alternatively, a gas flow or vacuum may be connected to the bowl to assist in movement of the microwave energy from the microwave generator or to otherwise provide a drying flow through the mixing chamber. Additional ports may be included to assist in the product flow or gas flow within the bowl. The use of a vacuum is preferred so as to not add additional pressure on the seals within the mixing chamber. A choking device may be added to the ducts or the ports (24) for sealing the microwave energy within the bowl. A typical design includes a lattice having honeycomb or similar shaped openings.

In the embodiment shown, the bowl surrounds a horizontally positioned agitator shaft. It is contemplated that the bowl and shaft may be positioned vertically. The choke at the position of the agitator shaft extension beyond the bowl serves as seal for microwave and may also serve as a seal for the product being processed. The discharge valve in this vertical embodiment is preferably positioned at the base of the bowl. The agitator may be formed to always be covered by product during processing, hence eliminating the need for a bowl flare. The bowl flare in the vertical mixer, if present, will be positioned at the transition level of the blades from the normal product level within the bowl to provide sufficient spacing for arc prevention. In the vertical embodiment, variations in the access opening for the bowl are contemplated. One possible variation would be to form the bowl into separable upper and lower portions.

The microwave heating source in conjunction with an agitator creates a relatively uniform heating of the product, whether liquid, particulate or slurry. The bowl wall also serves as a heat sink, to assist in maintaining the temperature of the product within a desired range. Various sanitary fittings and a plurality of sensors may be included in the mixer as desired. Further, the materials and design of the bowl, agitator, etc. are preferably chosen for application to food grade products or otherwise adapted to the specific application for the mixer.

The present disclosure includes a description and illustration of a number of exemplary embodiments. It should be understood by those skilled in the art from the foregoing that various other changes, omissions and additions may be made therein, without departing from the spirit and scope of the invention, with the invention being identified by the foregoing claims.

What is claimed is:

1. An apparatus for heating and processing a product, the apparatus comprising:
a mixing bowl for retaining a quantity of product, the bowl having a rounded base portion, an extended upper portion and two end walls;
an agitator positioned within the base portion of the bowl for rotation about an axis, the agitator having a rotational path closely spaced with the inside wall of the base portion, the upper portion of the bowl dimensional spaced from the rotational path to prevent arcing between the agitator and the inside bowl wall;
a motor for rotation of the agitator about the rotational axis, the agitator having a drive shaft positioned along the rotational axis and having a portion projecting outwardly of at least one end wall of the bowl;
a microwave energy source directed into the bowl for heating the product; and
a choke surrounding the outwardly projecting portion of the agitator shaft, the choke formed to seal the bowl along the agitator shaft to prevent microwave leakage.

2. An apparatus as in claim 1 wherein the upper portion of the bowl comprises an outwardly flared transition wall formed between the base and upper portion of the bowl.

3. An apparatus as in claim 2 wherein the outwardly flared portion initiates within the bowl wall adjacent the position of the axis of the shaft.

4. An apparatus as in claim 3 wherein the upper end of the outwardly flared transition is formed level with or at a position above a fill-line for product within the bowl.

5. An apparatus as in claim 1 wherein the agitator is formed a series of scraper blades mounted on arms that project outwardly from the shaft, the scraper blades defining the rotational path of the agitator.

6. An apparatus as in claim 5 wherein the scraper blades are angled with respect to the axial dimension of the bowl for promoting mixing of the product within the bowl.

7. An apparatus as in claim 1 wherein the choke includes a first collar closely spaced with and surrounding the shaft and an outer sealing collar surrounding the first collar and radially spaced therefrom.

8. An apparatus as in claim 7 wherein the first collar and the sealing collar are fixed to an end wall of the bowl.

9. An apparatus as in claim 8 wherein the radial spacing between the first collar and the sealing collar communicates with the spacing between the first collar and the shaft.

10. An apparatus as in claim 9 wherein the shaft spacing of the first color is less than the radial spacing with the outer sealing collar.

11. An apparatus as in claim 10 wherein a sealing cap is formed axially outwardly of the sealing collar.

12. An apparatus as in claim 1 wherein a hinged lid is provided for covering an opening in the bowl formed adjacent the extended upper end of the bowl, the lid sealing the bowl in a closed position.

13. An apparatus as in claim 12 wherein a series of ports are formed on the bowl, the ports providing access to the interior of the bowl, and wherein at least one port is connected to the microwave energy source and directing the microwave energy into the bowl.

14. An apparatus for heating and processing a product, the apparatus comprising:
a mixing bowl for retaining a quantity of product, the bowl having a rounded base portion, an extended upper portion and two end walls, the upper portion having outwardly flared transition portion formed between the base and upper portion of the bowl;
an agitator positioned within the base portion of the bowl for rotation about an axis, the agitator having a rotational path closely spaced with the inside wall of the base portion and dimensionally spaced from the upper portion of the bowl by the outwardly flared transition portion;
a motor for rotation of the agitator about the rotational axis, the agitator having a drive shaft positioned along the rotational axis and having a portion projecting outwardly of the bowl;
a microwave energy source directed into the bowl for heating the product; and
a choke surrounding the agitator shaft, the choke formed to seal the bowl along the projection of the agitator shaft to prevent microwave leakage.

15. An apparatus as in claim 14 wherein the outwardly flared transition of the bowl initiates at a position adjacent the position of the axis of the shaft.

16. An apparatus as in claim 15 wherein the upper end of the outwardly flared transition is formed level with or at a position above a fill-line for product within the bowl.

17. An apparatus as in claim 14 wherein the agitator comprises a series of scraper blades mounted on arms that project outwardly from the shaft, the scraper blades defining the rotational path of the agitator, and the scraper blades angled with respect to the axial dimension of the bowl.

18. An apparatus as in claim 14 wherein the choke includes a first collar closely spaced with and surrounding the shaft and an outer sealing collar surrounding the first collar and radially spaced therefrom, the radial spacing between the first collar and the sealing collar communicates with the spacing between the first collar and the shaft and wherein the shaft spacing of the first color is less than the radial spacing with the outer sealing collar.

19. An apparatus as in claim 14 wherein a hinged lid is provided for covering an opening in the bowl formed adjacent the extended upper end of the bowl, the lid sealing the bowl in a closed position.

20. An apparatus as in claim 19 wherein a series of ports are formed on the bowl, the ports providing access to the interior of the bowl, and wherein at least one port is connected to the microwave energy source and directing the microwave energy into the bowl.
